(19) United States
(12) Patent Application Publication
(10) Pub. No.: US 2003/0061603 A1
(43) Pub. Date: Mar. 27, 2003

(54) Method and device for updating keyboard controller BIOS through serial port

(76) Inventor: Chih-Chien Tang, Taipei (TW)

Correspondence Address: BIRCH STEWART KOLASCH & BIRCH, PO BOX 747, FALLS CHURCH, VA, 22040-0747, US

(21) Appl. No.: 09/956,964

(22) Filed: Sep. 21, 2001

(51) Int. Cl. G06F 9/44; G06F 13/12

(52) U.S. Cl. 717/168; 710/65

(57) ABSTRACT

The invention provides a method and device for updating the keyboard controller basic input-output system (KBC BIOS) of a computer. The updating is performed by simple circuits controlled through serial ports. A user can select the items to be updated so as to save time and effort.

### BACKGROUND OF THE INVENTION

1. Field of the Invention

The invention relates to a method and device for updating the keyboard controller (KBC) basic input output system (BIOS) of a computer, and more particularly relates to a method and device for selectively updating parts of the keyboard controller BIOS through a serial port.

2. Related Art

The basic input output system is a section of a program stored in the read only memory (ROM) of a computer. It contains some basic subroutines of input and output, system tests during start, and reading information (such as volume of disks, existence of optical disk and the system time, etc.) from the complementary metal-oxide semiconductor (CMOS).

The BIOS is generally mounted on the CPU board of a computer. Recently, some higher function interface cards, such as 3D accelerators or SCSI cards, are also built with BIOS chips. Previously, the BIOS was usually updated by replacing the chip. Now, however, the BIOS can be updated via software as flash memories are used.

In the current BIOS 2000, the keyboard controller BIOS is structured in the Super I/O. It contains a two-kilobyte lockable boot block and a 62-kilobyte flash read only memory. The keyboard controller BIOS cannot be solely updated. It has to be combined with the whole BIOS and updated with the whole BIOS via a parallel port or boot disk. This process costs time and effort.

### SUMMARY OF THE INVENTION

The object of the invention is therefore to provide a method and device for updating the keyboard controller basic input-output system (KBC BIOS) of a computer. The updating is performed through a serial port. The items to be updated can be selected by a user. This saves time and effort.

A method for updating the keyboard controller basic input-output system according to the invention includes the steps of: connecting the computer, setting a mode, checking the system, checking the lock, updating the system and updating the lock.

A device for updating the keyboard controller basic input-output system according to the invention includes signal wires, a selection switch, an updating control circuit and a lock control circuit.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is a flowchart showing a method for updating the keyboard controller basic input-output system according to the invention;

FIG. 2 is a block diagram showing a device for updating the keyboard controller basic input-output system according to the invention;

FIG. 3 is a block diagram of an updating control circuit in an embodiment of the invention.

FIG. 4 is a block diagram of a lock control circuit in an embodiment of the invention.

### DETAILED DESCRIPTION OF THE INVENTION

The invention provides a method and device for updating the keyboard controller basic input-output system (KBC BIOS) of a computer through a serial port. The items to be updated can be selected by a user.

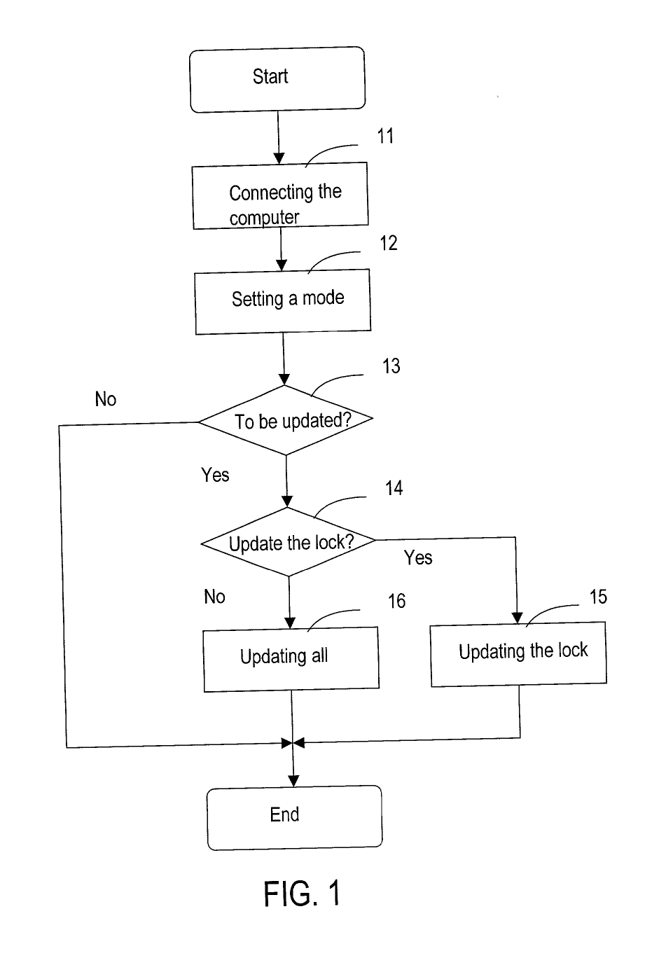

FIG. 1 is a flowchart showing a method for updating the keyboard controller basic input-output system according to the invention. The updating is performed by a remote computer connected to the target computer through serial ports for updating the boot block and flash memory of the KBC BIOS. The updating process includes the steps of connecting the computer (step 11), setting a mode (step 12), checking whether updating is being performed (step 13), checking whether the lock is being updated (step 14), updating the lock (step 15) and updating everything (step 16).

In step 11, a remote computer is connected to the target computer through serial ports of the two computers with signal wires. In step 12, an updating control circuit and a lock control circuit are provided for the user to select. In step 13, the system checks whether the mode is “not to update”, and ends if it is. In step 14, the system checks whether the mode is “update the lock”. In step 15, if the mode is set to “update the lock”, the system updates the flash memory of the target computer and then stops. In step 16, if the mode is set to “update all”, the system updates the boot block and the flash memory of the target computer and then stops.

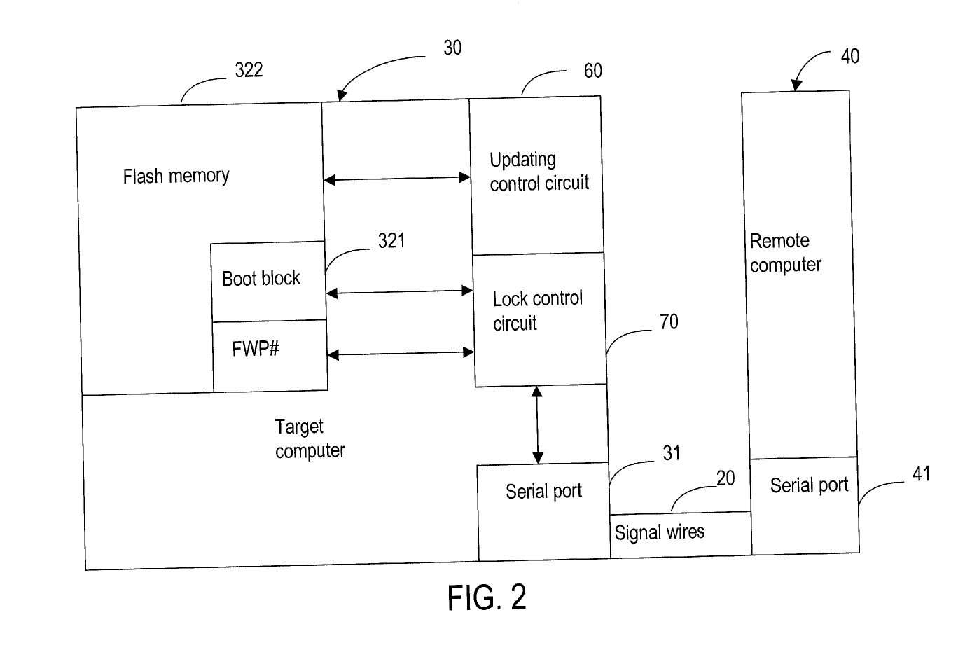

FIG. 2 is a block diagram showing a device for updating the keyboard controller basic input-output system according to the invention. The device uses a remote computer 40 for updating the basic input-output system 32 of a target computer 30. The basic input-output system 32 includes a boot block 321 and a flash memory 322. The device includes signal wires 20, a selection switch 50 (not shown in the drawing), an updating control circuit 60 and a lock control circuit 70.

The signal wires 20 connect a serial port 41 of the remote computer 40 and a serial port 31 of the target computer 30. A user uses the selection switch 50 (not shown in the drawings) to select a mode among “not to update”, “update the lock” and “update all”. The updating control circuit 60 is used to control the updating of the basic input-output system 32. It does not update if the mode is set to “not to update”. It permits updating if the mode is set to “update the lock” or “update all”. The lock control circuit 70 is used to control the updating of the boot block 321. It does not update the boot block 321 if the mode is set to “not to update” or “update the lock”. It permits updating of the boot block 321 if the mode is set to “update all”.

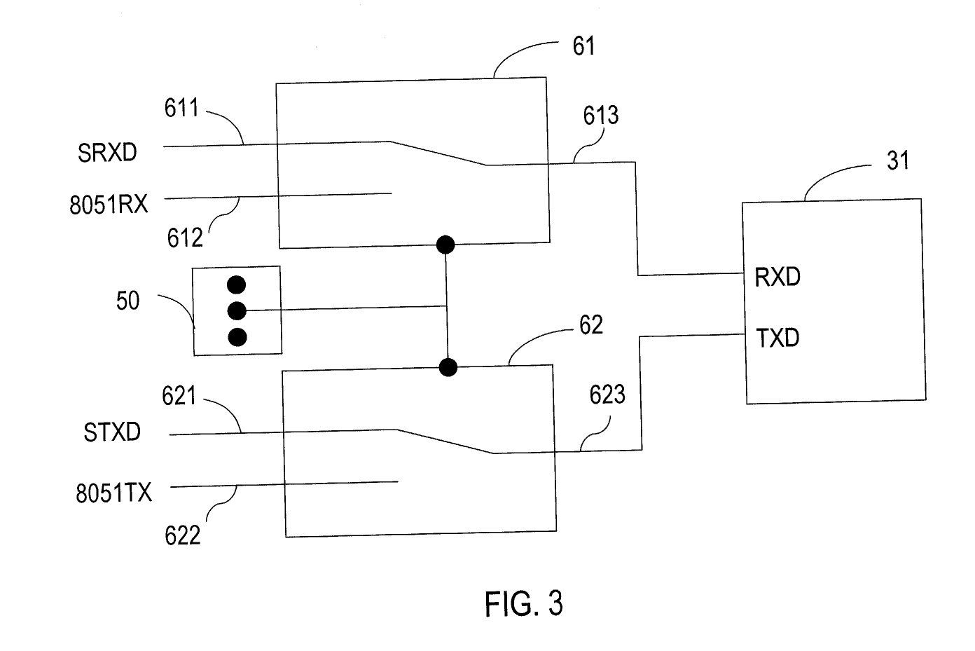

FIG. 3 is a block diagram of an updating control circuit in an embodiment of the invention. The updating control circuit 60 includes a receiving controller 61 and a transmission controller 62.

The receiving controller 61 is used for controlling signal receiving. It can be a two-for-one multiplexer including a first receiving port 611, a second receiving port 612 and a receiving output port 613. The first receiving port 611 connects to the SRXD of the target computer 30. The second receiving port 612 connects to the 8051RX of the target computer 30. The receiving output port 613 connects to the RXD of the serial port 31 of the target computer 30.

The transmission controller 62 is used for controlling signal transmission. It can be a two-for-one multiplexer including a first transmission port 621, a second transmission port 622 and a transmission output port 623. The first transmission port 621 connects to the STXD of the target computer 30. The second transmission port 622 connects to the 8051TX of the target computer 30. The transmission output port 623 connects to the TXD of the serial port 31 of the target computer 30.

The user can select a mode through the selection switch 50. If the mode is set to “not to update”, the first receiving port 611 will be connected to the receiving output port 613, and the first transmission port 621 will be connected to the transmission output port 623. If the mode is set to “update the lock” or “update all”, the second receiving port 612 will be connected to the receiving output port 613, and the second transmission port 622 will be connected to the transmission output port 623.

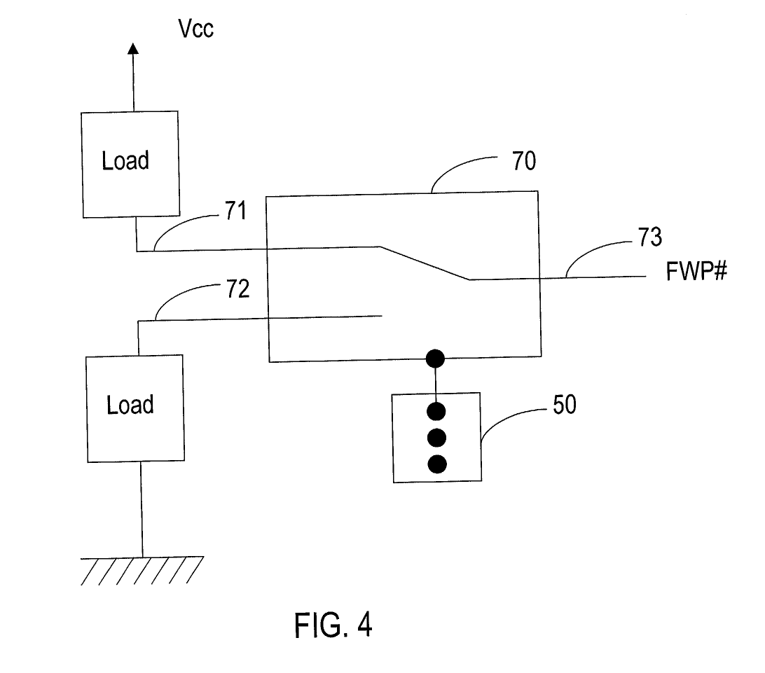

FIG. 4 is a block diagram of a lock control circuit in an embodiment of the invention. The lock control circuit 70 is a two-for-one mutiplexer including a first lock input port 71, a second lock input port 72 and a lock output port 73. The first lock input port 71 connects to the power voltage (Vcc) of the target computer 30. The second lock input port 72 connects to the ground. The lock output port 73 connects to the FWP# of the target computer 30.

The user can select a mode through the selection switch 50. If the mode is set to “not to update” or “update the lock”, the first lock input port 71 will be connected to the lock output port 73. If the mode is set to “update all”, the second lock input port 72 will be connected to the lock output port 73.

In conclusion, the invention provides a method and device for updating the keyboard controller basic input-output system (KBC BIOS) of a computer. The updating is performed by simple circuits controlled through serial ports. A user can select the items to be updated so as to save time and effort.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for updating keyboard controller basic input output system of a target computer by operating a remote computer connecting to the target computer and updating at least one of a boot block and a flash memory of the keyboard controller basic input output system, comprising steps of:
connecting serial port of the remote computer to serial port of the target computer with signal wires;
providing modes of “not to update”, “update the lock” and “update all” for user to select;
checking whether the mode is “not to update”, and ending if the mode is;
checking whether the mode is “update the lock”;
ending after updating flash memory of the target computer if the mode is “update the lock”;
ending after updating boot block and flash memory of the target computer if the mode is “to update all”.

2. A method for updating keyboard controller basic input output system of a target computer through serial port according to claim 1 wherein the step of providing modes is achieved by providing an updating control circuit and a lock control circuit for user to select.

3. A method for updating keyboard controller basic input output system of a target computer through serial port according to claim 2 wherein the updating control circuit comprises a receiving controller for controlling signal receiving; and a transmission controller for controlling signal transmission.

4. A method for updating keyboard controller basic input output system of a target computer through serial port according to claim 3 wherein said receiving controller is a two for one multiplexer comprising:
a first receiving input port connecting to SRXD of the target computer;
a second receiving input port connecting to 8051RX of the target computer; and
a receiving output port connecting to RXD of serial port of the target computer.

5. A method for updating keyboard controller basic input output system of a target computer through serial port according to claim 4 wherein said transmission controller is a two for one multiplexer comprising:
a first transmission input port connecting to STXD of the target computer;
a second transmission input port connecting to 8051TX of the target computer; and
a transmission output port connecting to TXD of serial port of the target computer.

6. A method for updating keyboard controller basic input output system of a target computer through serial port according to claim 5 wherein said first receiving input port is connected to said receiving output port, and said first transmission input port is connected to said transmission output port if the mode is “not to update”; and
said second receiving input port is connected to said receiving output port, and said second transmission input port is connected to said transmission output port when the mode is one of “update the lock” and “update all”.

7. A method for updating keyboard controller basic input output system of a target computer through serial port according to claim 2 wherein said lock controller is a two for one multiplexer comprising:
a first lock input port connecting to power voltage of the target computer;
a second lock input port connecting to ground; and
a lock output port connecting to FWP# of the target computer.

8. A method for updating keyboard controller basic input output system of a target computer through serial port according to claim 7 wherein said first lock input port is connected to said lock output port when the mode is one of “not to update” and “update the lock”; and
said second lock input port is connected to said lock output port when the mode is “update all”.

9. a device for updating keyboard controller basic input output system of a target computer by operating a remote computer connecting to the target computer and updating at least one of a boot block and a flash memory of the keyboard controller basic input output system, comprising:
signal wires for connecting serial port of the remote computer and serial port of the target computer;
a selection switch for providing modes of “not to update”, “update the lock” and “update all” for user to select;
an updating control circuit for controlling updating of said keyboard controller basic input output system by denying updating when the mode is set to “not to update”; and permitting updating when the mode is set to one of “update the lock” and “update all”; and
a lock control circuit for controlling updating of said boot block by denying updating the boot block when the mode is set to one of “not to update” and “update the lock”;
and permitting updating the boot block when the mode is set to one of and “update all”.

10. A device for updating keyboard controller basic input output system of a target computer through serial port according to claim 9 wherein the updating control circuit comprises a receiving controller for controlling signal receiving; and a transmission controller for controlling signal transmission.

11. A device for updating keyboard controller basic input output system of a target computer through serial port according to claim 10 wherein said receiving controller is a two for one multiplexer comprising:
a first receiving input port connecting to SRXD of the target computer;
a second receiving input port connecting to 8051RX of the target computer; and
a receiving output port connecting to RXD of serial port of the target computer.

12. A device for updating keyboard controller basic input output system of a target computer through serial port according to claim 11 wherein said transmission controller is a two for one multiplexer comprising:
a first transmission input port connecting to STXD of the target computer;
a second transmission input port connecting to 8051TX of the target computer; and
a transmission output port connecting to TXD of serial port of the target computer.

13. A device for updating keyboard controller basic input output system of a target computer through serial port according to claim 12 wherein said first receiving input port is connected to said receiving output port, and said first transmission input port is connected to said transmission output port if the mode is “not to update”; and
said second receiving input port is connected to said receiving output port, and said second transmission input port is connected to said transmission output port when the mode is one of “update the lock” and “update all”.

14. A device for updating keyboard controller basic input output system of a target computer through serial port according to claim 9 wherein said lock controller is a two for one multiplexer comprising:
a first lock input port connecting to power voltage of the target computer;
a second lock input port connecting to ground; and
a lock output port connecting to FWP# of the target computer.

15. A device for updating keyboard controller basic input output system of a target computer through serial port according to claim 14 wherein said first lock input port is connected to said lock output port when the mode is one of “not to update” and “update the lock”; and
said second lock input port is connected to said lock output port when the mode is “update all”.
